(19) United States
(12) Patent Application Publication
(10) Pub. No.: US 2008/0300784 A1
(43) Pub. Date: Dec. 4, 2008

(54) Route player

(76) Inventors: Amir Kleinstern, Kiryat Ono (IL); Ruby Salton, Modi'in (IL)

Correspondence Address: Ms. Ronny Fogel;Brux Software Solutions Ltd., 8 Gordon Street, Givatayim, 53235, IL

(21) Appl. No.: 11/802,951

(22) Filed: May 29, 2007

(51) Int. Cl. G01C 21/30

(52) U.S. Cl. 701/211; 705/14

(57) ABSTRACT

A route presentation compilation system comprising: a digital computer having a computer display; a database accessible by the digital computer, the database including a set of electronic maps of varying and selectable magnitude and scope and capable of being displayed on the computer display; presentation compilation software designed to enable route presentation compilation using the electronic maps displayed on the computer display by providing route points that include a route start and a route end, wherein the software is capable of calculating and displaying on the computer display a travel route between the route start and the route end; means for assigning at least one media object to at least one of the route points, selected from text documents, still images, video clips and voice notations; means for assigning at least one of a sound track, advertisement and 3^{rd} party information to at least part of the route between said route start and route end; means for defining setting defaults for the presentation; and means for playing the compiled presentation on the computer display according to the setting defaults.

### FIELD OF THE INVENTION

The present invention deals with digital route albums and more specifically recording, editing and playing a route map including various recorded media.

### BACKGROUNF OF THE INVENTION

Ever since the invention of the camera, travelers have recorded their travels by taking photographs, which they would later stick in a travel album, sometimes accompanied by hand-written notations, to be able to re-live the travel experience and share it with their family and friends.

In later years, travelers began to record their travels using video cameras, whereby the combined video-audio film could be later replayed.

With the advent of modern technology, specifically the Internet, travelers are now able to create their own travel website, to which they may upload their pictures, or alternatively use album services provided on the Internet, such as, for example, at www.flickr.com.

Additional functionality was made available with the appearance of GPS devices. With www.evervtrail.com, a traveler is able to display a travel map and insert still digital pictures and written notations into the map at the appropriate locations.

### SUMMARY OF THE INVENTION

According to a first aspect of the present invention, there is provided a route presentation compilation system comprising: a digital processor; display means connected with said processor; at least one electronic map accessible by said processor, said electronic maps capable of being displayed on said display means; presentation compilation software designed to enable route presentation compilation using said electronic maps displayed on said display means by providing route points including a route start and a route end, wherein said software is capable of calculating and displaying on said display means a travel route between said route start and said route end; means for assigning at least one media object to at least one of said route points, said means selected from the group consisting of text documents, still images, video clips and voice notations; means for assigning at least one of a sound track, advertisement and 3^{rd} party information to at least part of said route between said route start and route end; means for defining setting defaults for said presentation; and means for playing said compiled presentation on said display means according to said setting defaults.

According to a first embodiment of this aspect, the electronic map comprises one of: a map manually copied from a 3^{rd} party service, a map automatically copied from a 3^{rd} party service, and a map uploaded by the user.

According to a second embodiment of this aspect, the electronic map comprises one of: an outline map, a 3D map, a satellite picture, an aerial photograph and a 3D picture.

According to a third embodiment of this aspect, the provided route points comprise global coordinates obtained from an electronic positioning device, where the electronic positioning device may be GPS and where the coordinates may be obtained using cellular location-based services or transmitted radio beacons.

According to a fourth embodiment of this aspect, the means for assigning at least one media object comprise automatic means.

According to a fifth embodiment of this aspect, the advertisement comprises at least one of image, icon, movie and banner.

According to a sixth embodiment of this aspect, the 3^{rd} party information comprises at least one of news, weather information and recommendations.

According to a seventh embodiment of this aspect, the recommendations comprise recommendations regarding at least one of: food, lodging, activities, night life and shopping.

According to an eighth embodiment of this aspect, the means for assigning an advertisement comprise automatic means, where the automatic means may comprise context-related means, comprising at least one of: location, date and time.

According to a ninth embodiment of this aspect, the means for assigning a sound track comprise automatic means, where the automatic means may comprise location-related means.

According to a tenth embodiment of this aspect, the system comprises means for storing said compiled presentation, where said means for storing may comprise means for storing command data for building said presentation.

According to an eleventh embodiment of this aspect, the means for editing said presentation.

According to a twelfth embodiment of this aspect, the route comprises a plurality of partial routes.

According to a thirteenth embodiment of this aspect, the route is virtual, where the virtual route may comprise real world earth locations, real world outer space locations, or virtual locations.

According to a second aspect of the present invention, there is provided a route player comprising: a digital processor; display means connected with said processor; a route presentation accessible by said processor, said route presentation comprising: at least one electronic map; route point coordinates associated with said electronic map and defining a route, said route points including a route start, a route end and a current position indicator; at least one media object associated with at least one of said route points, said media object selected from the group consisting of text documents, still images, video clips and voice notations; at least one of a sound track, advertisements and 3^{rd} party information assigned to at least part of said route between said route start and route end; and setting defaults; and presentation means for presenting said route presentation on said display means, said presentation means comprising: means for moving said current position indicator along said route; means for playing said media objects associated with said current position; and at least one of means for playing said sound track, means for displaying said advertisements and means for displaying said 3^{rd} party information.

According to a first embodiment of this aspect, the electronic map comprises one of: a map manually copied from a 3^{rd} party service, a map automatically copied from a 3^{rd} party service, and a map uploaded by the user.

According to a second embodiment of this aspect, the electronic map comprises one of: an outline map, a 3D map, a satellite picture, an aerial photograph and a 3D picture.

According to a third embodiment of this aspect, the system comprises user controls for overriding said setting defaults.

According to a fourth embodiment of this aspect, the route points comprise global coordinates obtained from an electronic positioning device, where the electronic positioning device may be GPS and where the coordinates may be obtained using cellular location-based services or transmitted radio beacons.

According to a fifth embodiment of this aspect, the at least one media object is automatically associated with said at least one route point.

According to a sixth embodiment of this aspect, the advertisement comprises at least one of image, icon, movie and banner.

According to a seventh embodiment of this aspect, the 3^{rd} party information comprises at least one of news, weather information and recommendations, where the recommendations may comprise recommendations regarding at least one of: food, lodging, activities, night life and shopping.

According to an eighth embodiment of this aspect, the advertisement is assigned automatically, where the automatic assignment may comprise context-related means comprising at least one of: location, date and time.

According to a ninth embodiment of this aspect, the sound track is assigned automatically, where the automatic assignment may comprise location-related means.

According to a ninth embodiment of this aspect, the current position indicator comprises an avatar, where the avatar may comprise speech attributes or advertisement attributes and may be interactively designed by the user.

According to a tenth embodiment of this aspect, the route comprises a plurality of partial routes.

According to an eleventh embodiment of this aspect, the route is virtual, where the virtual route may comprise real world earth locations, real world outer space locations, or virtual locations.

According to a third aspect of the present invention, there is provided a method of compiling a route presentation, comprising the steps of: obtaining world coordinates defining points on said route, said points comprising at least a start point and an end point; obtaining an electronic map pertaining to said coordinates; obtaining at least one media object, said media object selected from the group consisting of text documents, still images, video clips and voice notations; obtaining at least one of a sound track, an advertisement and 3^{rd} party information; displaying said map; outlining said route points on said displayed map, thereby displaying the route; associating at least one of said media objects with at least one of said outlined route points; and associating at least one of said sound track, advertisement and 3^{rd} party information with at least part of said displayed route.

According to a first embodiment of this aspect, the method comprises storing said compiled presentation, where the storing may comprise storing command data for building said presentation.

According to a second embodiment of this aspect, obtaining an electronic map comprises one of: manually copying a map from a 3^{rd} party service, automatically copying a map from a 3^{rd} party service, and uploading a map.

According to a third embodiment of this aspect, the electronic map comprises one of: an outline map, a 3D map, a satellite picture, an aerial photograph and a 3D picture.

According to a fourth embodiment of this aspect, the world coordinates comprises obtaining coordinates from an electronic positioning device, where the electronic positioning device may be GPS and where the coordinates may be obtained using cellular location-based services or transmitted radio beacons.

According to a fifth embodiment of this aspect, associating at least one media object comprises automatically associating said media object with said at least one route point.

According to a sixth embodiment of this aspect, associating at least one media object comprises selecting media objects from a displayed list of media objects.

According to a seventh embodiment of this aspect, associating a sound track comprises selecting a sound track from a displayed list of sound tracks.

According to an eighth embodiment of this aspect, associating an advertisement comprises selecting an advertisement from a displayed list of advertisements, where said displayed list of advertisements comprises advertisements selected by an advertiser to be associated with at least part of said route points.

According to a ninth embodiment of this aspect, associating 3^{rd} party information comprises providing a link to a 3^{rd} party website.

According to a tenth embodiment of this aspect, the 3^{rd} party information comprises at least one of news, weather information and recommendations, where the recommendations may comprise recommendations regarding at least one of: food, lodging, activities, night life and shopping.

According to an eleventh embodiment of this aspect, associating said advertisement comprises automatically associating said advertisement, where the automatic assignment may comprise context-related association comprising at least one of: location, date and time.

According to a twelfth embodiment of this aspect, associating a sound track comprises automatically associating a sound track, where the automatic association may comprise location-related association.

According to a thirteenth embodiment of this aspect, the method comprises defining setting defaults.

According to a fourteenth embodiment of this aspect, the route comprises a plurality of partial routes.

According to a fifteenth embodiment of this aspect, the route is virtual, where the virtual route may comprise real world earth locations, real world outer space locations, or virtual locations.

According to a fourth aspect of the present invention, there is provided a method of playing a route presentation, comprising the steps of: displaying an electronic map according to predefined settings; outlining a route on said map according to predefined settings, said route comprising route points including at least a start point, an end point and a current position indicator; moving said current position indicator along said route; when said current position indicator reaches one of said route points, checking whether a media object has been associated with said reached route point and if it has—playing said media object according to predefined settings; and checking whether at least one of a sound track, an advertisement and 3^{rd} party information has been associated with at least part of the route and if it has—playing said at least one sound track, advertisement or 3^{rd} party information according to predefined settings.

According to a first embodiment of this aspect, the method comprises using user controls for overriding said predefined settings, where the overriding may comprise at least one of: controlling volume and controlling media object display.

According to a second embodiment of this aspect, playing said media object comprises displaying said media object in one of: a window overlapping said displayed map and a window not overlapping said displayed map.

According to a third embodiment of this aspect, the said route is virtual, where the virtual route may comprise real world earth locations, real world outer space locations, or virtual locations.

### BRIEF DESCRIPTION OF THE DRAWINGS

For a better understanding of the invention, its operating advantages and the specific objects attained by its uses, reference should be made to the accompanying drawings, in which:

FIG. 1 shows the various components of the route player system according to the present invention;

FIG. 2 is a flowchart describing the process of preparing the route presentation according to an embodiment of the present invention;

FIG. 3 is a flowchart showing the process of operating the route player in Play mode according to an embodiment of the present invention; and

FIG. 4 shows an exemplary screen and user controls of the route player according to the present invention.

### DETAILED DESCRIPTION OF PREFERRED EMBODIMENTS

The present invention provides a dynamic route player, able to incorporate all types of digital media and resulting in a multimedia presentation during which the route is being unfolded.

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

A route according to the present invention may be any one of a journey, excursion, flight, travel, trek, or a log of a person's locations during one or more days.

In some embodiments, a route may be a virtual route, not actually taken, or at least partly not physically taken, comprising real world coordinates or location names entered or pointed at by the user, or selected in any other manner.

In some embodiments, a route may be a virtual route comprising real world, as yet unreachable locations, such as distant starts or planets.

In some embodiments, a route may be a virtual route comprising virtual locations in a virtual world or place, not existing in the real world, such as may be created, for example, using Second Life (www.secondlife.com).

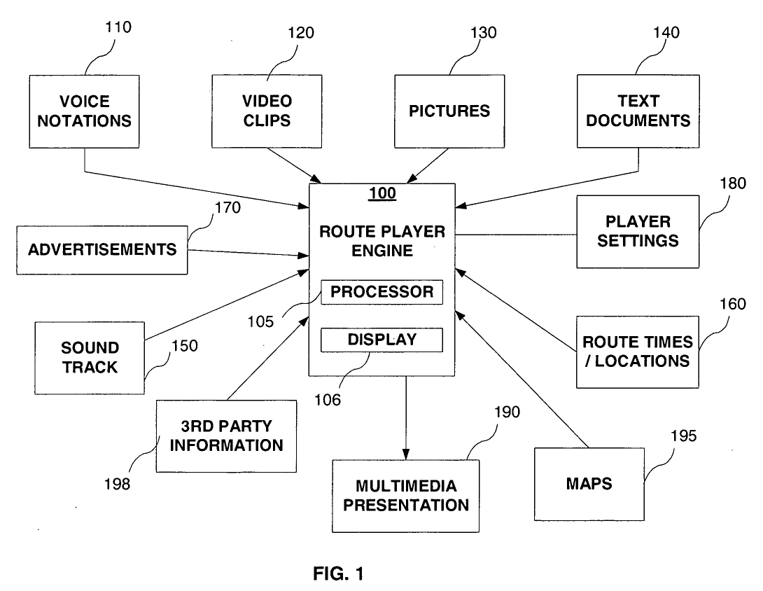

FIG. 1 shows the various components of the route player system according to the present invention. At the heart of the system lies the route player engine 100, comprising a digital processor 105 and display means 106. Player engine 100 may comprise a web server running a web-based application. Alternatively, route player engine 100 may comprise a stand-alone application on a local computer or a plug-in to other programs, or a mobile device application. Route player engine 100 may include programs adapted to capture the various media types, as will be detailed below and maps 195, e.g. GIS maps, downloadable for example from /www.mapcruzin.com/.

Display means 106 may comprise a computer monitor, a TV set, cell-phone display, PDA display, etc.

The various media types uploadable to the web server, for use by the route player engine 100, may include: voice notations 110, recorded using a mobile phone speaker, or any kind of voice recorder known in the art, during or after the voyage; video clips 120, taken by a mobile phone camera or any other video camera; still pictures 130, taken by a mobile phone camera or any other digital camera, or captured by a conventional camera and later scanned into digital form; and text documents 140, compiled by any document creation program such as MS Word. A sound track 150 may also be uploaded to the web server.

According to some embodiments of the present invention, the route player incorporates advertisements 170 provided by advertisers, in any media type known in the art such as images, icons, movies, banners, etc. The advertiser may indicate in what context his advertisement should be available, e.g. countries, regions, route type (city, nature) etc.

According to some embodiments of the present invention the route player incorporates links to 3rd party information sources 198, to be used for obtaining information relevant to the played route, as will be explained in detail below.

In an alternative embodiment, all or part of the media to be used by the route player 100 may be stored on other websites or services, e.g. www.flickr.com and accessed by route player 100 when required.

In a preferred embodiment of the present invention, the traveler is equipped with a global positioning device, e.g. GPS, LBS service or any other method for locating position, preferably incorporated in his mobile device, whereby locations and time stamps 160 are recorded and may later be uploaded to the web server.

According to some embodiments, location coordinates may be obtained using technologies such as Place Lab (http://www.placelab.org/), where the actual location is calculated by listening to radio beacons received from devices transmitting them, such as 802.11 (Wi-Fi) access points, WiMAX access points, GSM cell phone towers, and fixed Bluetooth devices that exist in large numbers around us. These beacons all have unique or semi-unique IDs, for example, a MAC address. The physical location of the traveler's receiver (embedded in his mobile device), can be calculated by looking up the associated beacons' positions in a beacon database, and estimating the traveler's position referenced to the beacons' positions.

According to some embodiments of the present invention, positioning information is uploaded to the web server on-the-fly, using any available connection between the handset and the server like: GPRS, WiFi, WiMAX, HSDPA etc.

Route player engine 100 combines the various media to create a dynamic multimedia presentation 190 according to user-defined settings 180, as will be explained in detail below.

Once the various media have been uploaded to the web server, the presentation may be prepared.

According to some embodiments of the present invention, the tasks of preparing and playing the route presentation are performed in parallel, whereby initiating the route player in the “Play” mode prompts the parallel processes and the route is being played as it is being compiled.

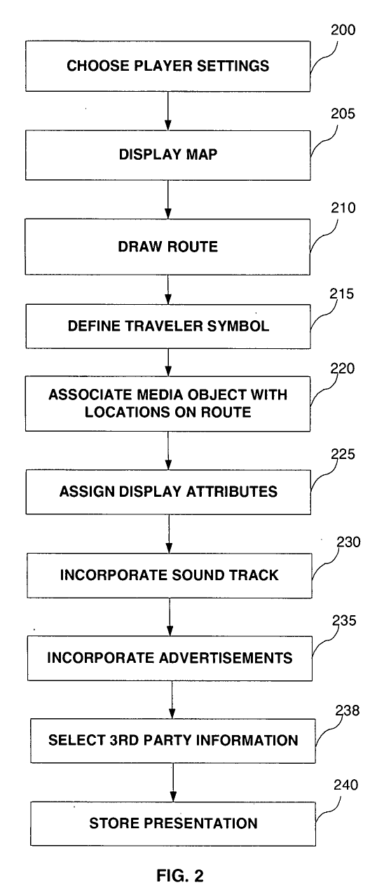

FIG. 2 is a flowchart describing the process of preparing the route presentation.

In step 200, the user is given the choice of player settings, as will be explained in more detail below.

In step 205, a map of the route area is displayed. According to some embodiment, the system displays a map of the relevant region, in accordance with the uploaded GPS (or any other location technology such as Europe's Galileo or Russia's GLONASS) coordinates. Alternatively, the user may navigate to the route region manually, using navigation and zooming tools as known in the art. The map may be displayed in any available mode, such as a satellite map, an outline map, a hybrid map comprising both, a 3D map or picture, a photograph, e.g. aerial photograph available, for example, from Ofek-Air, Israel, etc. The maps may be acquired by the system in any of a variety of ways, such as, for example, manually or automatically copied from a 3^{rd} party service or uploaded by the user from any available source.

In step 210, the system draws a line on the map, by connecting the various GPS (or any other location technology available) coordinates. The line may have indications of media-related locations and/or indications of start and end points of the route. The user may be given the option to control the line type (e.g. dotted), width and color. The user may manually add or delete media-related locations from the route.

In step 215, the user may define the object symbolizing the traveler, which may be any geometrical shape, colored or not, or it may alternatively be represented by an avatar, chosen by the user from a menu of displayed avatars.

According to some embodiments of the present invention, the avatar may be designed by the user being presented with the graphical choice of body characteristics and clothes or other accessories. This option provides additional advertisement opportunities.

According to some embodiments of the present invention, the avatar may play the role of a tour guide, by being assigned speech capabilities, provided for example from Cepstral Voices, available from Cepstral LLC (www.cepstral.com). The text to be spoken out by the avatar may be provided by the user-created text notes, or from 3^{rd} party information related to the currently visited site. The user may have control over the avatar's voice quality and volume.

In step 220, the relevant media objects are associated with the appropriate locations on the route. According to some embodiment, the system displays a list of all uploaded media and the user may proceed to manually associate each or part of the displayed list items with the appropriate route points, using “drag and drop” or any other manual mode of association.

According to some embodiments, the system may automatically match each media object to its appropriate location based, for example, on the coordinates and time stamp supplied with the various media types.

In step 225, the user may assign display attributes to the various media, such as animation effect like fade in, fade out, zoom in and out, tilt, pan etc. to the stills image display, transition effects between images, and the like.

In step 230, the user may be presented with a list of sound tracks to accompany the presentation, for part or all of its length, to be manually chosen by the user and associated with the appropriate route part(s).

According to some embodiments, one or more sound tracks may be automatically associated with the route, according to various criteria such as route location where the route took place, culture, such as traditional music, etc.

In step 235, the user may be presented with a list of advertisements to be incorporated in his presentation. The list may change per media point, or be constant for the entire route. In order to provide the user with an incentive to incorporate advertisements in his presentation, a reimbursement model may be applied whereby the user is paid by the advertiser per viewing.

According to some embodiments, the advertisements may be assigned automatically to at least part of the media points or to the entire route, according to context, e.g. route location, season, time of day, etc.

In step 238, the user may select from a list of 3^{rd} party information providers, which data he would like to include, as default, in his route presentation. The 3^{rd} party information may include weather information related to the viewed area, relevant news, recommendations and commentaries regarding food, lodging, activities, night life, shopping, etc.

According to some embodiments, the 3^{rd} party information will be automatically presented in the information panel of the route player. Viewers of the route presentation may have the choice of viewing additional or other information in this panel, related to the time when the route was taken, or to any other time, including future dates.

The complete presentation is then stored (step 240), ready to be played. In another embodiment, only a skeleton of the presentation is stored, such as command data for building the presentation, requiring less storage space, it may be re-compiled or executed each time the “Play” mode is initiated according to the instruction data.

At any stage during or following the preparation of the presentation, the user may be presented with an Edit mode, enabling him to change any of the user-defined settings 180, delete or move media objects, change or add display attributes, add or delete advertisement sources and 3^{rd} party information sources, etc.

Throughout the description, any mention of route may refer to a route comprising several distinct partial routes. The partial routes may be defined to be played consecutively, according to a pre-defined order, or one at a time.

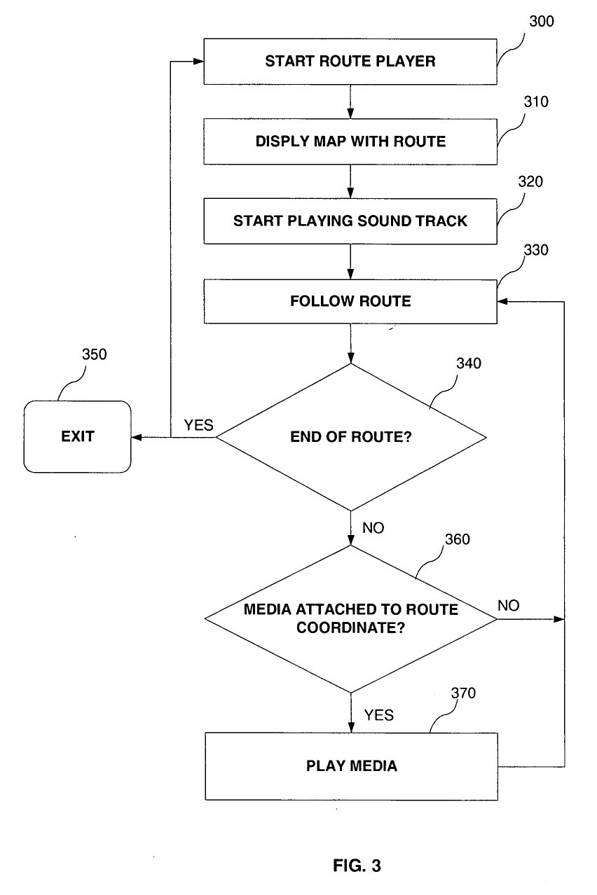

FIG. 3 is a flowchart showing the process of operating the route player in Play mode.

In step 300, the viewer launches the route player application.

In step 310, the route map is displayed. The map may be displayed from a bird's view, or in a zoom-in mode, according to the default display mode in the player settings (180), or according to the last display mode selected. The viewer may change the display mode while viewing the presentation.

The sound track (if incorporated) starts playing (step 320) and an object symbolizing the traveler starts moving along the route (step 330) from the starting point, following the route originally taken. If a “speaking” avatar has been defined, the viewer may have control over the avatar's voice quality and volume.

According to some embodiments, the viewer may manually move the avatar, or its equivalent, from one point to another along the route.

In step 340, the system checks whether the end point has been reached. If it has, the presentation is ended and the viewer has an option to replay it, or exit the route player program. If the end point has not been reached, the system checks, in step 360, whether it has reached a coordinate to which one or more media objects had been attached and continues following the route, moving the traveler's symbol, until such point is reached.

In step 370, the system plays the media object attached to the point it has reached. The playing may take various forms, according to the type(s) of media:
Voice notation or avatar speech—will be played as recorded. If a sound track accompanies the presentation, its volume may automatically be decreased for the duration of the voice notation;
Still images—will be displayed;
Text documents—will either be displayed or spoken out by the avatar, or both;
Video clips—will be displayed with or without sound, as recorded. If a sound track accompanies the presentation, its volume may automatically be decreased for the duration of the video clip;

The displayed media object may be displayed in a separate window, on any side of the map. Alternatively, the displayed objects may partially or completely cover the map while displayed, according to the default display mode defined in the player settings (180), or according to the last media display mode selected. The viewer may change the media display mode while viewing the presentation.

A media object may be displayed for a given time period, possibly defined in the player settings (180), or the viewer may interactively end the media display and resume the route, whereby the media window(s) will be closed.

According to some embodiments of the invention, the viewer may have control over the moving symbol, e.g. control its motion speed, or send it to the next point to which media objects were attached.

Throughout the route playing, the selected advertisements may be displayed/played according to the advertisement type. For example, a banner may be displayed in a special space reserved in the map window, or a movie may be played as one of the media types attached to a specific media point on the route, etc.

Throughout the route playing an information panel may show 3^{rd} party information, automatically as defined by the author (the traveler), or as selected by the viewer while the route is being played. The information may include weather information related to the viewed area, relevant news, recommendations and commentaries regarding food, lodging, activities, night life, shopping, etc. The information may be related to the time of the trek (past) or to current or future dates selectable by the viewer or pre-defined. For example, the viewer may wish to visit Sequoia National Park. He watches a route in the site and enters his desired travel date(s). He may see, for example, if the park is closed during his desired vacation schedule, get recommendations for lodging, get the weather forecast for the relevant time, etc. In another example, when watching the route the viewer can see what was the actual temperature on the displayed day, special events that took place in the park during the route, etc. The information may be presented in a special information window or on the maps as icons or faded pictures.

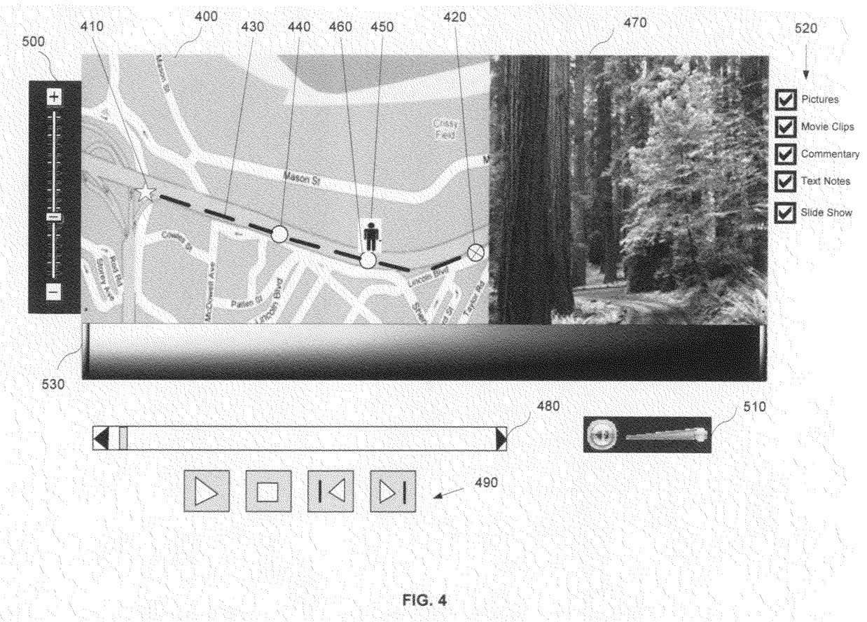

FIG. 4 shows an exemplary screen and user controls of the route player according to the present invention. A map 400 is displayed on the left-hand side of the screen, including a route starting point 410, a route end point 420, a dotted line 430 indicating the route, a marked point 440 along the route, which has already been visited during the current session and a second marked point 460, next to which the avatar 450 representing the user is seen. A picture is displayed in window 470, on the right-hand side of the screen, which is the picture associated with point 460 presently visited.

The navigation controls (480, 490) at the bottom of the screen may be used in various modes, depending on the active window (map or image/video clip). If the active window is the map window, the navigation controls may be used for affecting the speed and direction of following the route, as well as enable stopping and resuming. Alternatively, if the active window is the image/video-clip window, the navigation tools may be used to flip between still images (next/previous/first/last) or to control the video playing, as known in the art.

In an alternative embodiment, separate navigation controls may be provided for the two windows.

User controls may additionally include zoom control 500 and volume control 510, as known in the art.

Media window 470 may be controlled by controls 520, enabling the viewer to show or hide certain media types.

An information panel 530 may provide a display area for 3^{rd} party information, as explained above.

1. A route presentation compilation system comprising:
a digital processor;
display means connected with said processor;
at least one electronic map accessible by said processor, said electronic maps capable of being displayed on said display means;
presentation compilation software designed to enable route presentation compilation using said electronic maps displayed on said display means by providing route points including a route start and a route end, wherein said software is capable of calculating and displaying on said display means a travel route between said route start and said route end;
means for assigning at least one media object to at least one of said route points, said means selected from the group consisting of text documents, still images, video clips and voice notations;
means for assigning at least one of a sound track, advertisement and 3^{rd} party information to at least part of said route between said route start and route end;
means for defining setting defaults for said presentation; and
means for playing said compiled presentation on said display means according to said setting defaults.

2. The system of claim 1, wherein said electronic map comprises one of: a map manually copied from a 3^{rd} party service, a map automatically copied from a 3^{rd} party service, and a map uploaded by the user.

3. The system of claim 1, wherein said electronic map comprises one of: an outline map, a 3D map, a satellite picture, an aerial photograph and a 3D picture.

4. The system of claim 1, wherein said provided route points comprise global coordinates obtained from an electronic positioning device.

5. The system of claim 4, wherein said electronic positioning device is GPS.

6. The system of claim 4, wherein said coordinates are obtained using cellular location-based services.

7. The system of claim 4, wherein said coordinates are obtained using transmitted radio beacons.

8. The system of claim 1, wherein said means for assigning at least one media object comprise automatic means.

9. The system of claim 1, wherein said advertisement comprises at least one of image, icon, movie and banner.

10. The system of claim 1, wherein said 3^{rd} party information comprises at least one of news, weather information and recommendations.

11. The system of claim 10, wherein said recommendations comprise recommendations regarding at least one of: food, lodging, activities, night life and shopping.

12. The system of claim 1, wherein said means for assigning an advertisement comprise automatic means.

13. The system of claim 12, wherein said automatic means comprise context-related means.

14. The system of claim 13, wherein said context comprises at least one of: location, date and time.

15. The system of claim 1, wherein said means for assigning a sound track comprise automatic means.

16. The system of claim 15, wherein said automatic means comprise location-related means.

17. The system of claim 1, additionally comprising means for storing said compiled presentation.

18. The system of claim 17, wherein said means for storing comprise means for storing command data for building said presentation.

19. The system of claim 1, additionally comprising means for editing said presentation.

20. The system of claim 1, wherein said route comprises a plurality of partial routes.

21. The system of claim 1, wherein said route is virtual.

22. The system of claim 21, wherein said virtual route comprises real world earth locations.

23. The system of claim 21, wherein said virtual route comprises real world outer space locations.

24. The system of claim 21, wherein said virtual route comprises virtual locations.

25. A route player comprising:
a digital processor;
display means connected with said processor;
a route presentation accessible by said processor, said route presentation comprising:
at least one electronic map;
route point coordinates associated with said electronic map and defining a route, said route points including a route start, a route
end and a current position indicator;
at least one media object associated with at least one of said route points, said media object selected from the group consisting of text documents, still images, video clips and voice notations;
at least one of a sound track, advertisements and 3^{rd} party information assigned to at least part of said route between said route start and route end; and
setting defaults; and
presentation means for presenting said route presentation on said display means, said presentation means comprising:
means for moving said current position indicator along said route;
means for playing said media objects associated with said current position; and
at least one of means for playing said sound track, means for displaying said advertisements and means for displaying said 3^{rd} party information.

26. The system of claim 25, wherein said electronic map comprises one of: a map manually copied from a 3^{rd} party service, a map automatically copied from a 3^{rd} party service, and a map uploaded by the user.

27. The system of claim 25, wherein said electronic map comprises one of: an outline map, a 3D map, a satellite picture, an aerial photograph and a 3D picture.

28. The system of claim 25, additionally comprising user controls for overriding said setting defaults.

29. The system of claim 25, wherein said route points comprise global coordinates obtained from an electronic positioning device.

30. The system of claim 29, wherein said electronic positioning device is GPS.

31. The system of claim 29, wherein said coordinates are obtained using cellular location-based services.

32. The system of claim 29, wherein said coordinates are obtained using transmitted radio beacons.

33. The system of claim 25, wherein said at least one media object is automatically associated with said at least one route point.

34. The system of claim 25, wherein said advertisement comprises at least one of image, icon, movie and banner.

35. The system of claim 25 wherein said 3^{rd} party information comprises at least one of news, weather information and recommendations.

36. The system of claim 35, wherein said recommendations comprise recommendations regarding at least one of: food, lodging, activities, night life and shopping.

37. The system of claim 25, wherein said advertisement is assigned automatically.

38. The system of claim 37, wherein said automatic assignment comprises context-related means.

39. The system of claim 38, wherein said context comprises at least one of: location, date and time.

40. The system of claim 25, wherein said sound track is assigned automatically.

41. The system of claim 40, wherein said automatic assignment comprises location-related means.

42. The system of claim 25, wherein said current position indicator comprises an avatar.

43. The system of claim 42, wherein said avatar comprises speech attributes.

44. The system of claim 42, wherein said avatar comprises advertisement attributes.

45. The system of claim 42, wherein the avatar is interactively designed by the user.

46. The system of claim 25, wherein said route comprises a plurality of partial routes.

47. The route player of claim 25, wherein said route is virtual.

48. The system of claim 47, wherein said virtual route comprises real world earth locations.

49. The system of claim 47, wherein said virtual route comprises real world outer space locations.

50. The system of claim 47, wherein said virtual route comprises virtual locations.

51. A method of compiling a route presentation, comprising the steps of:
obtaining world coordinates defining points on said route, said points comprising at least a start point and an end point;
obtaining an electronic map pertaining to said coordinates;
obtaining at least one media object, said media object selected from the group consisting of text documents, still images, video clips and voice notations;
obtaining at least one of a sound track, an advertisement and 3^{rd} party information;
displaying said map;
outlining said route points on said displayed map, thereby displaying the route;
associating at least one of said media objects with at least one of said outlined route points; and
associating at least one of said sound track, advertisement and 3^{rd} party information with at least part of said displayed route.

52. The method of claim 51, additionally comprising storing said compiled presentation.

53. The method of claim 52, wherein said storing comprises storing command data for building said presentation.

54. The method of claim 51, wherein said obtaining an electronic map comprises one of: manually copying a map from a 3^{rd} party service, automatically copying a map from a 3^{rd} party service, and uploading a map.

55. The method of claim 51, wherein said electronic map comprises one of: an outline map, a 3D map, a satellite picture, an aerial photograph and a 3D picture.

56. The method of claim 51, wherein said obtaining world coordinates comprises obtaining coordinates from an electronic positioning device.

57. The method of claim 56, wherein said electronic positioning device is GPS.

58. The method of claim 56, wherein said obtaining world coordinates comprises using cellular location-based services.

59. The method of claim 56, wherein said obtaining world coordinates comprises using transmitted radio beacons.

60. The method of claim 51, wherein said associating at least one media object comprises automatically associating said media object with said at least one route point.

61. The method of claim 51, wherein said associating at least one media object comprises selecting media objects from a displayed list of media objects.

62. The method of claim 51, wherein said associating a sound track comprises selecting a sound track from a displayed list of sound tracks.

63. The method of claim 51, wherein said associating an advertisement comprises selecting an advertisement from a displayed list of advertisements.

64. The method of claim 63, wherein said displayed list of advertisements comprises advertisements selected by an advertiser to be associated with at least part of said route points.

65. The method of claim 51, wherein said associating 3^{rd} party information comprises providing a link to a 3^{rd} party website.

66. The method of claim 51, wherein said 3^{rd} party information comprises at least one of news, weather information and recommendations.

67. The method of claim 66, wherein said recommendations comprise recommendations regarding at least one of: food, lodging, activities, night life and shopping.

68. The method of claim 51, wherein associating said advertisement comprises automatically associating said advertisement.

69. The method of claim 68, wherein said automatic association comprises context-related association.

70. The method of claim 69, wherein said context comprises at least one of: location, date and time.

71. The method of claim 51, wherein said associating a sound track comprises automatically associating a sound track.

72. The method of claim 71, wherein said automatic association comprises location-related association.

73. The method of claim 51, additionally comprising defining setting defaults.

74. The method of claim 51, wherein said route comprises a plurality of partial routes.

75. The method of claim 51, wherein said route is virtual.

76. The method of claim 75, wherein said virtual route comprises real world earth locations.

77. The method of claim 75, wherein said virtual route comprises real world outer space locations.

78. The method of claim 75, wherein said virtual route comprises virtual locations.

79. A method of playing a route presentation, comprising the steps of:
displaying an electronic map according to predefined settings;
outlining a route on said map according to predefined settings, said route comprising route points including at least a start point, an end point and a current position indicator;
moving said current position indicator along said route;
when said current position indicator reaches one of said route points, checking whether a media object has been associated with said reached route point and if it has—playing said media object according to predefined settings; and
checking whether at least one of a sound track, an advertisement and 3^{rd} party information has been associated with at least part of the route and if it has—playing said at least one sound track, advertisement or 3^{rd} party information according to predefined settings.

80. The method of claim 79, additionally comprising using user controls for overriding said predefined settings.

81. The method of claim 80, wherein said overriding predefined settings comprises at least one of: controlling volume and controlling media object display.

82. The method of claim 79, wherein playing said media object comprises displaying said media object in one of: a window overlapping said displayed map and a window not overlapping said displayed map.

83. The method of claim 79, wherein said route is virtual.

84. The method of claim 83, wherein said virtual route comprises real world earth locations.

85. The method of claim 83, wherein said virtual route comprises real world outer space locations.

86. The method of claim 83, wherein said virtual route comprises virtual locations.
